(19) United States
(12) Patent Application Publication
(10) Pub. No.: US 2003/0206503 A1
(43) Pub. Date: Nov. 6, 2003

(54) MULTI-ELEMENT DETECTOR AND MULTI-CHANNEL SIGNAL CONDITIONER FOR USE READING MULTIPLE TRACKS OF OPTICAL DISKS HAVING DIVERSE FORMATS

(76) Inventors: Tatiana Tania Kosoburd, Lod (IL); Jacob Finkelstein, Kfar-Saba (IL); Eliyahu Chachamov, Rehovot (IL); Itzhak Katz, Petach-Tiqwa (IL); Michael Naor, Rehovot (IL); Steven R. Rogers, Emek Sorek (IL)

Correspondence Address: FISH & NEAVE, 1251 AVENUE OF THE AMERICAS, 50TH FLOOR, NEW YORK, NY, 10020-1105, US

(21) Appl. No.: 09/800,415

(22) Filed: Mar. 5, 2001

Related U.S. Application Data
(63) Continuation-in-part of application No. 09/464,359, filed on Dec. 15, 1999, now abandoned.

(51) Int. Cl. G11B 7/095

(52) U.S. Cl. 369/44.29; 369/44.41

(57) ABSTRACT

Apparatus and methods are provided for using a single multi-element detector and multi-channel signal conditioning circuitry to simultaneously read multiple tracks from either a CD disk or a DVD disk. The multi-element detector has a staggered arrangement and includes elongated detector elements, so that multiple reading beams reflected from multiple tracks of a CD disk are projected onto the detector, as are multiple reading beams reflected from multiple tracks of a DVD disk. The multi-channel signal conditioning circuitry conditions the signals produced by the multi-element detector, and produces signals for each of the tracks that is simultaneously read, as well as a tracking error signal, a focus error signal, a magnification error signal, and signals useful for reading DVD-RAM disks and for rapidly accessing tracks on an optical disk.

### REFERENCE TO RELATED APPLICATIONS

The present application is a continuation-in-part of U.S. patent application Ser. No. 09/464,359, filed Dec. 15, 1999.

### FIELD OF THE INVENTION

The present invention relates to methods and apparatus for simultaneously reading multiple tracks of an optical disk, and more specifically to a multi-element detector array and multi-channel signal conditioner for use in an optical drive that reads multiple tracks simultaneously from CD and DVD format optical disks.

### BACKGROUND OF THE INVENTION

Due to their high storage density, long data retention life, and relatively low cost, optical disks have become the predominant media format for distributing information. For example, the compact disk (CD) format, developed and marketed for the distribution of musical recordings, has replaced vinyl records. Similarly, high-capacity, read-only data storage media, such as CD-ROMs have become prevalent in the personal computer field for the distribution of software and databases. The DVD format may soon replace videotape as the distribution medium of choice for video information. Additionally, drives capable of reading DVD disks are becoming increasingly prevalent in personal computers, and the DVD format is starting to be used for distribution of software.

Although DVD disks have a much larger data storage capacity than CD disks, CD disks are currently far more common as a distribution medium for software and other computer-readable data. Thus, to best ensure success in the marketplace, optical drives preferably should be capable of reading both DVD disks and CD disks. Physical differences between these formats, however, such as the spacing between tracks on the disk (track pitch), the size of the data features (pits), the depth of the clear substrate that covers the reflective surface of the disks, and the wavelength of the light used to read the disks, may require drives capable of reading both types of disk to be more complex than drives capable of reading only a single type of disk. For example, U.S. Pat. No. 5,696,750, to Katayama, describes a system having a common reflected-light optical path for reading CD and DVD disks.

Physically, the information bearing portion of an optical disk consists of a series of pits, or bumps, arranged to form a spiral track. Data is encoded in the length of individual pits and the length of the space between pits. An optical pickup assembly reads the data by reflecting a laser beam off of the optical disk. Because the disk is rotated, the laser beam alternately reflects from the pits and the spacing between the pits. This causes discernable changes in the reflected laser beam which are detected and decoded to recover data stored on the optical disk.

As used herein, a data track refers to a portion of the spiral data track corresponding to a single rotation of an optical disk. A drive capable of reading multiple data tracks simultaneously reads multiple such portions of the spiral track at once. For disks having multiple concentric spiral tracks, a data track refers to one revolution of one of the concentric spiral tracks. For optical disks having concentric circular tracks, a data track refers to one such circular track.

U.S. Pat. No. 5,793,549 to Alon et al., describes an optical disk reader that reads multiple data tracks simultaneously, for example, using multiple laser beams. The multiple laser beams, which may be obtained by splitting a single beam using a diffraction grating or by providing multiple laser sources, are focused on and aligned with corresponding tracks of the optical disk. The reflected beams are then detected and decoded. Thus, a disk rotated at 6× the standard speed in a disk drive reading ten tracks at a time may provide a maximum data rate equivalent to a 60× single beam drive, but without the complications associated with high rotational speeds.

In addition to being aligned with the data tracks, the beams in a multi-beam optical pickup must be maintained at specified distances from each other to avoid crosstalk and to properly align the beams with the detectors. These distances are determined by the spacing of the tracks (i.e., the track pitch), the magnification of the optics, and the size and spacing of the detectors used to read the information. Typically, the minimum spacing is greater than the track pitch, requiring the multiple laser beams to be spaced circumferentially as well as radially with respect to the optical disk.

The track pitch of a CD type disk is approximately 1.6 microns, while the track pitch of a DVD type disk is approximately 0.74 microns. For a multi-beam system, it is necessary to arrange and align the beams so that each beam focuses on a track, and to arrange the detectors so that each beam reflected from an optical disk is projected onto a detector. Since the track pitch of DVD and CD type disks are different, the spacing of the beams and the spacing of the detectors for a system that simultaneously reads multiple tracks of a DVD type disk is different than the spacing of the beams and detectors for a system that simultaneously reads multiple tracks of a CD type disk. This presents unique difficulties in building a single optical drive that simultaneously reads multiple tracks of both CD and DVD disks. Thus, for example, one cannot simply multiply the number of detectors employed in such devices as shown in the aforementioned Katayama patent, because the spacings for the non-central beams differ for each of the two formats.

Due to differences in the wavelength of light that is used to read DVD and CD disks, a system that reads both formats will typically have two laser diodes (one for each wavelength), and combine the beams using a beamsplitter. Thus, arranging the spacing of the beams may be handled before the separate optical paths of the two laser diodes are combined by the beamsplitter. However, it is difficult and costly to provide separate optical paths for light reflected from the optical disk, and to use two different sets of detectors having different spacings between detector elements.

The electronics for conditioning the signals produced by the detector elements adds further to the difficulty and cost of manufacturing an optical disk reader that can read both DVD and CD formatted disks. For a drive that simultaneously reads multiple tracks from a CD or DVD disk, the signal conditioning electronics must be able to provide signals for each of the channels (i.e. tracks) for either type of disk, as well as signals for driving servos to correct focus and tracking errors, and other signals that may be useful in operating the drive.

It would therefore be desirable to provide methods and apparatus for simultaneously reading multiple tracks of both CD and DVD type optical disks using a single multi-element detector and an integrated multi-channel signal conditioning circuit.

It would further be desirable to provide a multi-element detector and multi-channel signal conditioning circuitry that can be used to simultaneously read multiple tracks of both CD and DVD type disks.

### SUMMARY OF THE INVENTION

In view of the foregoing it is an object of the present invention to provide methods and apparatus for simultaneously reading multiple tracks of both CD and DVD type optical disks using a single multi-element detector and an integrated multi-channel signal conditioning circuit.

It is a further object of the present invention to provide a multi-element detector and multi-channel signal conditioning circuitry that can be used to simultaneously read multiple tracks of both CD and DVD type disks.

These and other objects of the present invention are achieved by providing a multi-element detector comprising an array of elongated detector elements wherein adjacent detector elements are staggered by predetermined distances and may be offset from each other by predetermined distances. Multiple reading beams reflected from multiple tracks of a CD disk are projected onto the multi-element detector with a spacing and angle such that each of the beams is projected onto one of the detector elements of the multi-element detector. Similarly, multiple reading beams reflected from multiple tracks of a DVD disk are projected onto the same multi-element detector with a spacing and angle such that each of the reading beams corresponds to one of the detector elements.

A central detector element of the multi-element detector may be divided into four detector segments for use as a quad detector, generating astigmatic focus error signals and tracking signals. Additionally, two outermost detector elements may each be divided into two segments, for use in providing magnification error signals for the multiple reading beams used to read multiple tracks of a DVD disk, or for crosstalk correction.

The signals from the multi-element detector are sent to multi-channel signal conditioning circuitry, that generates numerous error signals, such as a focus error signal, a tracking error signal, and a magnification or magnitude error signal. The multi-channel signal conditioning circuitry also produces numerous signals that are useful for controlling a CD or DVD drive, such as signals for determining whether a DVD-RAM drive is reading a header, a land area, or a groove area, and signals for use in track counting and seeking operations. Additionally, the multi-channel signal conditioning circuitry filters each of the signals, and combines signals from the segments of multi-segment elements of the multi-element detector, thereby providing useful data channel signals of each of the multiple elements of the multi-element detector.

### BRIEF DESCRIPTION OF THE DRAWINGS

The above and other objects and advantages of the present invention will be apparent upon consideration of the following detailed description taken in conjunction with the accompanying drawings, in which like characters refer to like parts throughout, and in which:

FIG. 1 is a simplified representation of a multi-beam optical pickup suitable for use in the present invention;

FIG. 2 shows a holographic optical element used in the multi-beam optical pickup of FIG. 1;

FIGS. 3A and 3B show multiple reading beams projected on a portion of a CD disk and a DVD disk, respectively;

FIG. 3C shows spots produced by multiple reading beams reflected from a surface of a CD disk and a DVD disk, as well as the orientation of a detector element of the multi-element detector of the present invention;

FIG. 4 shows a multi-element detector constructed in accordance with the principles of the present invention;

FIG. 5 shows spots reflected from a CD disk and a DVD disk projected onto the multi-element detector of FIG. 4;

FIGS. 6 and 7 show alternative embodiments of a multi-element detector constructed in accordance with the principles of the present invention, with spots reflected from a CD and a DVD disk;

FIG. 8 shows an overview of the multi-channel signal conditioning circuitry of the present invention;

FIG. 9 shows a portion of the multi-channel signal conditioning circuitry that produces a filtered signal for each of the channels;

FIG. 10 shows a portion of the multi-channel signal conditioning circuitry of the present invention that produces a focus error signal;

FIGS. 11A and 11B show portions of the multi-channel signal conditioning circuitry of the present invention that produce tracking error signals using a push-pull method and a differential phase method, respectively;

FIG. 12 shows a portion of the multi-channel signal conditioning circuitry of the present invention that produces a magnification or magnitude error signal;

FIG. 13 shows a portion of the multi-channel signal conditioning circuitry of the present invention that produces signals useful for reading DVD-RAM disks; and

FIG. 14 shows a portion of the multi-channel signal conditioning circuitry of the present invention that assists in rapidly accessing a given track of an optical disk.

### DETAILED DESCRIPTION OF THE INVENTION

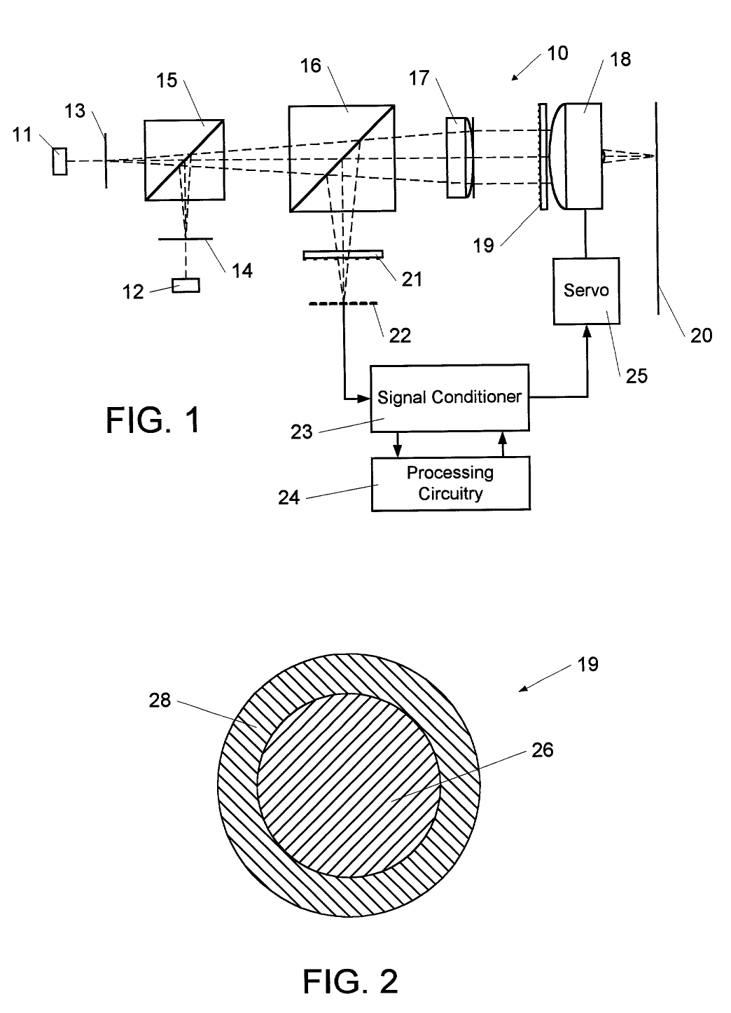

Referring to FIG. 1, a simplified diagram of illustrative dual-path multi-beam optical pickup 10, built in accordance with the principles of the present invention, is described. Optical pickup 10 may be used for reading optical disk 20, which may be either a CD format or a DVD format disk. Except for detector 22 and signal conditioning circuitry 23, the individual components of optical pickup 10 may comprise elements used in previously known optical disk readers.

Light source 11, typically a laser diode, selectively generates a beam of light having a first wavelength, suitable for reading a first type of optical media. For reading a CD disk, light source 11 preferably generates a beam having a wavelength of 785 nm. Similarly, light source 12, typically a laser diode, selectively generates a beam of light having a second wavelength, suitable for reading a second type of optical media. For reading a DVD disk, light source 12 preferably generates a beam having a wavelength of 658 nm.

Light from light source 11 passes through diffractive element 13, which splits the beam of light into multiple reading beams, spaced at a first preselected distance between adjacent beams, and aligned at a first angle with respect to the radial direction of an optical disk, so that each of the multiple reading beams will be incident on a corresponding track on the first type of optical disk (e.g. a CD disk). Similarly, the beam generated by light source 12 is split into multiple reading beams by diffractive element 14. The reading beams generated by diffractive element 14 are spaced apart by a second preselected distance, and are aligned at a second angle with respect to the radial direction of an optical disk, so that each of the reading beams will be incident on a corresponding track on the second type of optical disk (e.g. a DVD disk).

After the beam from light source 11 or 12 has been split into multiple reading beams by diffractive element 13 or 14, respectively, the multiple reading beams pass through beamsplitter 15, which combines the separate optical paths of the light generated by light sources 11 and 12 into a single optical path. Beamsplitter 15 passes the beams from light source 11 through the beamsplitter, while reflecting the beams from light source 12, so that light from either source shares a common optical path. Beamsplitter 15 preferably comprises a dichoric beamsplitter, that passes light having the first wavelength, and reflects light having the second wavelength. Alternatively, beamsplitter 16 may comprise a typical half-silvered mirror beamsplitter, or a polarizing beamsplitter, assuming that the light from light source 11 is polarized differently than the light from light source 12.

Next, the reading beams pass through beamsplitter 16, and collimator 17, and are focused onto a surface of optical disk 20 by objective 18 to project diffraction limited spots onto the surface of optical disk 20. If multibeam optical system 10 is required to read two different types of optical media that have transparent substrates of different thickness, such as DVD and CD disks, the reading beams must pass through holographic optical element (HOE) 19 before passing through objective 18. HOE 19 is divided into two parts—an inner and an outer part. The inner part of HOE 19 is designed so that light having the first wavelength may be focused on the first type of optical media by objective 18, while light having the second wavelength may be focused on the second type of optical media by the same objective 18. Thus, the inner part of HOE 19 effectively forms a dichoric lens, which has different optical properties for light having the first wavelength than for light having the second wavelength. A holographic optical element having the properties of the inner part of HOE 19 is described in the aforementioned patent to Katayama, which is incorporated herein by reference.

The outer part of HOE 19 is designed so that it has no effect on light having the second wavelength (for reading a DVD disk), and restricts the numerical aperture of the objective lens for light at the first wavelength (for reading a CD disk). Any portion of the light at the first wavelength that passes through the outer portion of HOE 19 is directed out of the optical axis, so that it forms a large diameter ring. As a result, the outer part of objective 18 has no effect on the spots projected on the first type of optical media (CD disks).

Optical disk 20 contains a reflective layer in which data is recorded in the form of pits (or bumps) in the reflective layer. Alternatively, some recordable optical disks use physical or chemical properties of the reflective layer material, such as its magnetic properties, or its ability to polarize incident light, to record the data.

The reading beams focused on optical disk 20 are reflected by the reflective layer and modulated by the data recorded therein. The reflected beams travel back through objective lens 18, HOE 19, and collimator 17, and are directed by beamsplitter 16 toward focus element 21 and multi-element detector 22. Focus element 21 is a holographic element that introduces astigmatism into at least a central reading beam, so that an astigmatic focus detector may be used. Alternatively, focus element 21 may comprise microlenses, a wedge lens, or holographic element for use with push-pull focus error detection. As will be described in greater detail hereinbelow, if push-pull focus error detection is used, an alternative embodiment of multi-element detector 22 having detector elements appropriate for detecting the focus error must also be used.

In accordance with the principles of the present invention, multi-element detector 22, which will be described in greater detail hereinbelow, comprises multiple optical detector elements, each of which detects the intensity of light reflected from a corresponding track of optical disk 20. One of the optical detector elements of multi-element detector 22, preferably a central element, may comprise a quadrant detector, for use in detecting focus and tracking errors. Alternatively, additional focus and/or tracking detectors may be used with multi-element detector 22.

Multi-element detector 22 provides electrical signals corresponding to the light beams impinging thereon. These signals are sent to multi-channel signal conditioning circuitry 23, which produces conditioned output signals for each of the tracks that are being simultaneously read, as well as tracking and focus error signals to drive servo 25. Conditioned signals for each of the tracks (channels) that are being simultaneously read are sent to processing circuitry 24. Multi-channel conditioning circuitry 23 may also receive control signals from processing circuitry 24, and may produce additional signals useful for servo control, magnification error correction, or other operation of an optical reader.

Processing circuitry 24 decodes and processes the signals from multi-channel signal conditioning circuitry 23 to recover the data recorded on the optical disk. Processing circuitry 24 may also perform various control tasks, such as driving a servo (not shown) to position optical pickup 10 over a selected set of tracks. The functions performed by processing circuitry 24 may be similar to those described, for example, in commonly assigned U.S. Pat. No. 5,627,805, which is incorporated herein by reference. Additional circuitry (not shown) converts the data to a format suitable for use by a computer or other processing device, and acts as an interface between the optical disk reader and computer or other processing device.

It will be understood by one skilled in the art that diffractive elements 13 and 14 alternatively may comprise holographic elements. Additionally, beamsplitter 16 may comprise a half-silvered mirror or a polarizing beam splitter. In addition, many other changes may be made to the physical arrangement of the optical components of multibeam optical system 10 without departing from the present invention.

The beams reflected from optical disk 20 are directed toward multi-element detector 22 regardless of the format of the disk from which they are reflected. In accordance with the principles of the present invention, multi-element detector 22 is designed to handle different formats of optical media, wherein the first type of optical media and the second type of optical media have different spacing between tracks, as is the case for CD and DVD disks.

FIG. 2 shows a more detailed view of HOE 19. As described above, HOE 19 includes inner part 26 and outer part 28. Inner part 26 is designed to have different optical properties for light having the first wavelength than for light having the second wavelength, so that light having the first wavelength may be focused on the first type of optical media by objective 18, while light having the second wavelength may be focused on the second type of optical media by the same objective 18. Outer part 28 has no effect on light having the second wavelength, and restricts the numerical aperture of objective 18 for light having the first wavelength by directing such light off of the optical axis, so that the outer part of objective 18 has no effect on illumination spots projected onto the first type of optical media.

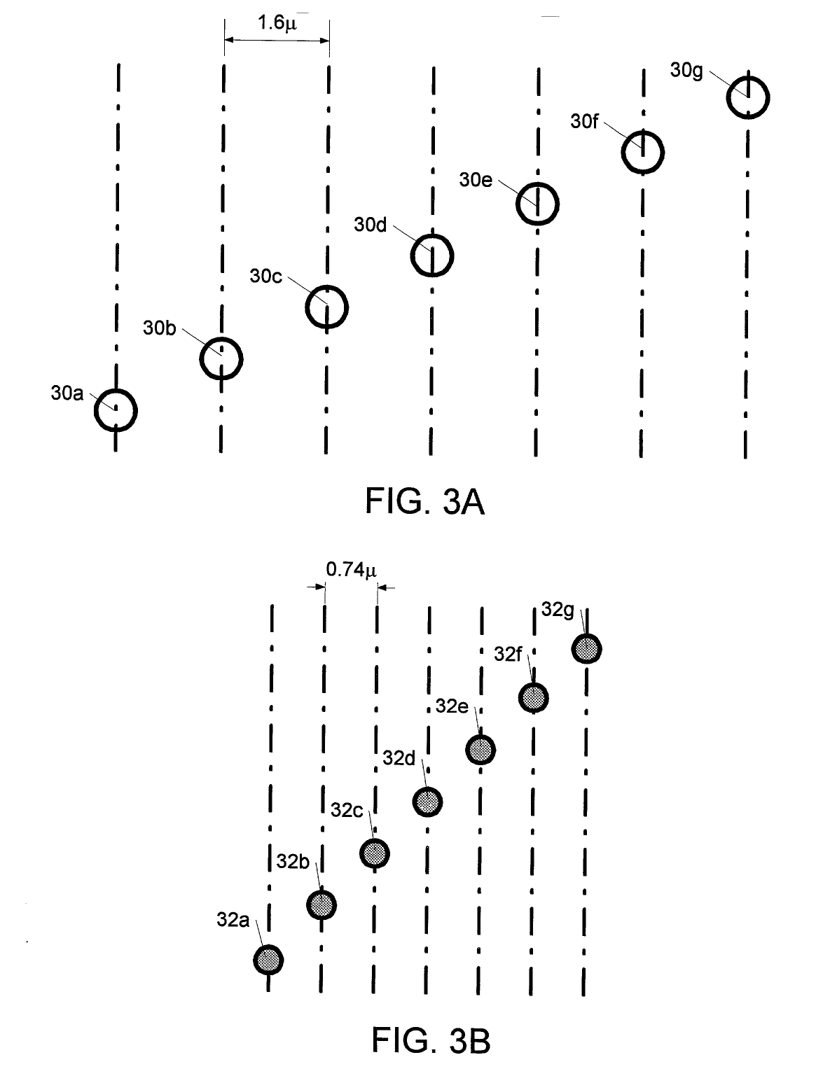

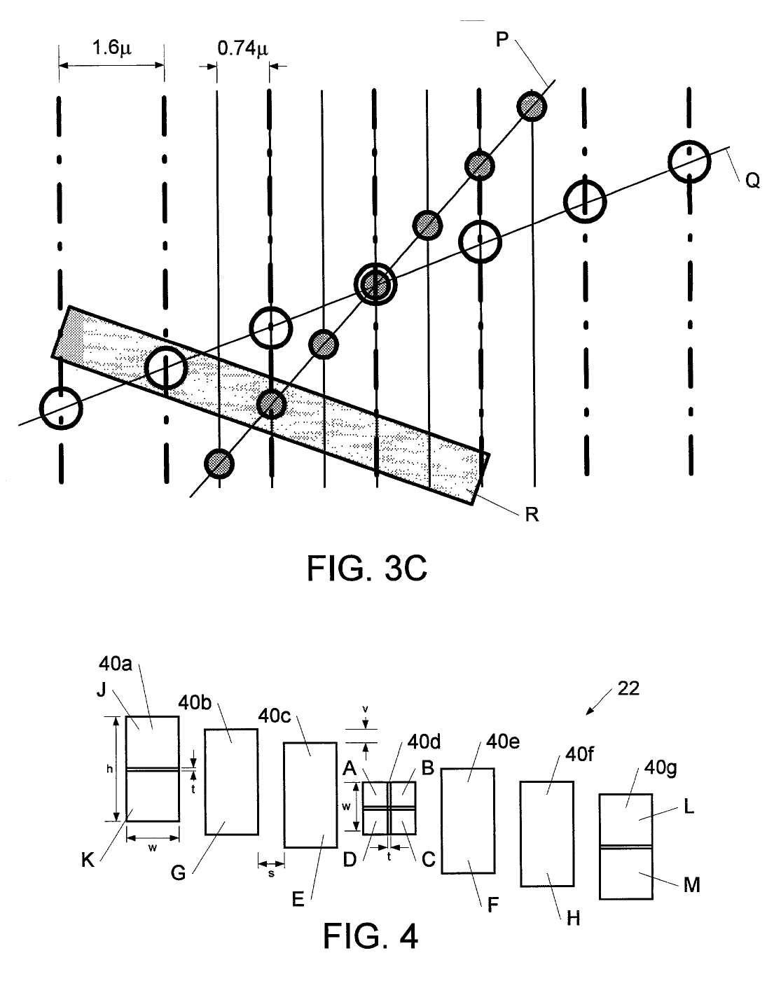

The difference in beam spacing for DVD disks and CD disks is demonstrated in FIGS. 3A and 3B. In FIG. 3A, spots 30a-30g are projected onto the tracks of a CD disk having a track pitch of 1.6 microns. In FIG. 3B, spots 32a-32g are projected onto the tracks of a DVD disk, having a track pitch of 0.74 microns.

The angles of the rows of spots shown in FIGS. 3A and 3B are meant only for the purpose of illustrating that the rows of spots projected onto a surface of optical disk 20 may have different angles relative to a radial direction of the disk, depending on the disk type. In an actual system, the angles would be much larger—typically above 80° from a radial direction, making the rows of spots nearly tangential on optical disk 20. The angle that should be used depends on the track pitch of the media to be read, the size of the spots projected onto the disk, the minimal distance between the spots necessary to avoid crosstalk and other interference between the beams, and the spacing of the detectors.

The angles of the reading beams may be adjusted so that when the reflected beams are imaged on multi-element detector 22, the spots projected on a CD disk and the spots projected on a DVD disk have the same spacing along one axis, and variable spacing along another axis, while aligning with two different track pitches. This is demonstrated in FIG. 3C, which shows row P of multiple reading beams projected onto a DVD disk, row Q of multiple beams projected onto a CD disk, and Detector element R, showing the alignment of the detector elements of multi-element detector 22. As can be seen, spots in row P and row Q align with two different track pitches, but when projected onto detector element R of multi-element detector 22, the beams align along an axis parallel to a long direction of detector element R. The beams are equally spaced along an axis perpendicular to the long direction of detector element R. This is achieved by proper design of diffractive elements 13 and 14, and of multi-element detector 22, and by their alignment or rotation.

Multi-Element Detector

FIG. 4 shows a multi-element detector for a seven beam system built in accordance with the principles of the present invention. Multi-element detector 22 comprises detector elements 40a-40g, each of which detects light reflected from a corresponding track of an optical disk. Each of elements 40a, 40b, 40c, 40e, 40f and 40g has an elongated shape with height h, and width w. Adjacent elements of multi-element detector 22 are separated from each other by a predetermined spacing s, and are staggered and offset relative to adjacent elements by a predetermined distance v. In a preferred embodiment, w is approximately 50 microns, h is approximately 120 microns, v is approximately 4.2 microns, and s is approximately 9.8 microns.

As used herein, a staggered arrangement of detector elements is one in which a top or bottom edge of an element is differently positioned along an axis than the top or bottom edge of an adjacent element. Elements are offset from each other along an axis if their centers are differently positioned along that axis. Thus, detector elements 40a-40g are both staggered, since their top and bottom edges have differing vertical positions, and offset, since they are centered at varying vertical positions.

Element 40d, the central element of multi-element detector 22, preferably has both height and width w, and preferably comprises a quadrant detector with four detector segments, A, B, C, and D. The segments are separated by a distance t, which is approximately 3 microns in a preferred embodiment. As is well-known in the art, signals generated by these segments may be used in astigmatic focus error detection, and for detecting errors in tracking. For both CD and DVD disks, the central reading beam reflected from the disk will be projected onto the center of element 40d.

Elements 40a and 40g, the outermost elements of multi-element detector 22, are preferably split into two segments each, labeled J, K, L, and M. Segments J and K, and segments L and M, also are separated by distance t. These segments are used to generate a signal indicative of variations in track pitch or magnification error for DVD disks. In use, the outermost reading beams reflected from a DVD disk will be projected so that they illuminate each of segments J, K, L, and M equally when the magnification of the system is correctly adjusted, and when the track pitch of the disk is correct. When the magnification is too high or the track pitch is slightly too wide, the spacing between images projected onto the detectors will increase, and segments J and M will receive more illumination than segments K and L. Conversely, when the magnification of the system is too low or the track pitch is too small, segments K and L will receive more illumination than segments J and M. By calculating (J+M)−(K+L), the system may produce a magnification error signal for use with a magnification correction system such as is described in commonly assigned U.S. Pat. No. 5,729,512, which is incorporated herein by reference. Segments J, K, L, and M may also be used to estimate parameters for crosstalk cancellation.

The other detector elements of multi-element detector 22, elements 40b, 40c, 40d, and 40e, each comprises a single detector segment, labeled G, E, F, and H, respectively.

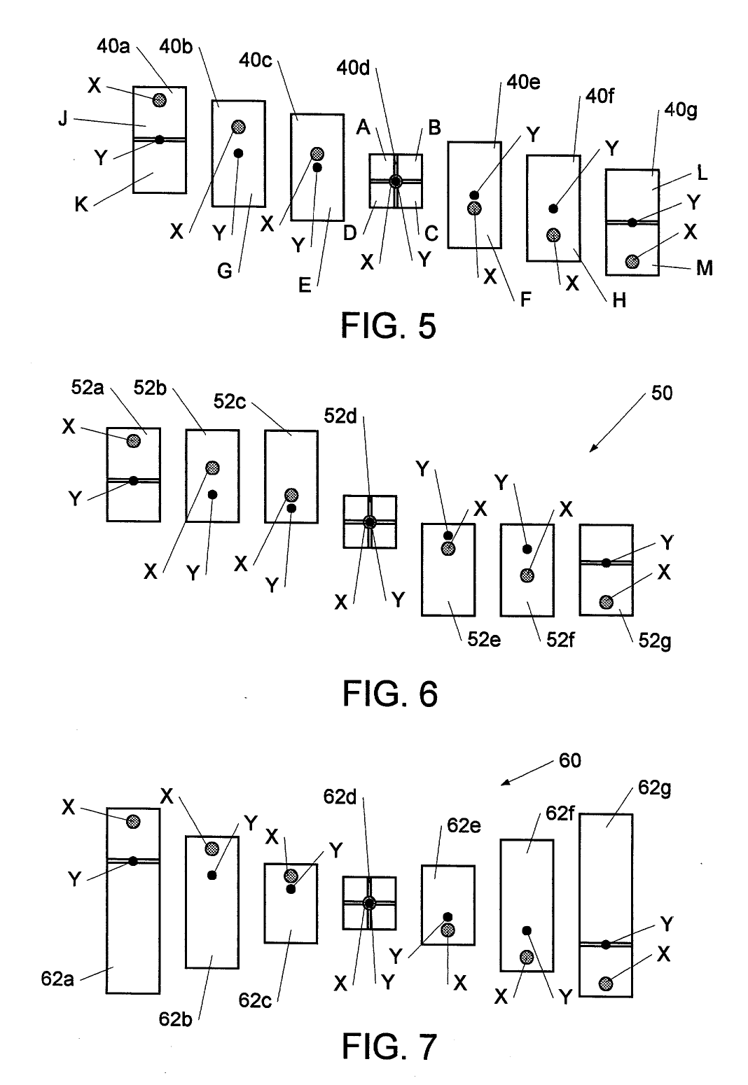

In FIG. 5, multi-element detector 22 is shown with spots X, representing incident light reflected from a CD disk when optical pickup 10 is used to read a CD disk, and spots Y, formed by incident light reflected from a DVD disk when optical pickup 10 is alternatively used to read a DVD disk. As can be seen, each of the spots projected onto multi-element detector 22 from either type of disk corresponds to one of the detector elements. Both a central one of spots X and a central one of spots Y are incident on the same region of the central detector element. For non-central detector elements, spots X are incident on different regions of the detector elements than spots Y.

The angle at which the beams are projected onto the surface of the disk, and at which the reflected beams are projected onto multi-element detector 22 varies according to the type of disk. This variation is introduced by diffractive elements 13 and 14, which may be oriented at different angles to produce lines of beams having spacing and orientation necessary to align with multiple tracks of an optical disk, and to be projected onto elements of multi-element detector 22. The angle at which both sets of beams are projected onto multi-element detector 22 also depends on the orientation of multi-element detector 22.

For a CD disk, the track pitch is approximately twice the track pitch of a DVD disk, and the spacing between the beams is approximately the same as for a DVD disk, so the angle at which the beams are projected onto multi-element detector 22 must be greater than the angle at which the beams reflected from a DVD disk are projected onto multi-element detector 22. Adjustment of this angle permits the spacing of the beams to be different for each of the two types of disks, while permitting beams projected onto a surface of multi-element detector 22 to be equally spaced in a horizontal direction, and spaced differently only in a vertical direction.

Elements 40a, 40b, 40c, 40e, 40f, and 40g are elongated in a vertical direction (i.e. height h is greater than width w), and have a staggered and offset arrangement, permitting them to detect light projected onto multi-element detector 22 over a large vertical area. This ability to detect light over a large vertical area, combined with the ability to project spots at different angles for two different types of optical media, provides an ability to use a single set of detectors to detect multiple reading beams reflected from two types of optical media having different spacing between tracks.

Referring now to FIG. 6, an alternative embodiment of the multi-element detector of the present invention is described. Multi-element detector 50, which may be used in optical pickup 10 as a replacement for multi-element detector 22, comprises detector elements 52a-52g. Detector elements 52a-52c and 52e-52g have an elongated shape. As before, central detector element 52d has a square shape, and is divided into four segments, which may be used to detect focus and tracking errors. Outermost detector elements 52a and 52g are each divided into two segments, which may be used in the manner described hereinabove to detect magnification errors in the DVD beams (spots Y).

Detector elements 52c and 52e are staggered and offset vertically in opposite directions with respect to central detector element 52d, and detector elements 52a and 52b are aligned with detector 52c, while detector elements 52f and 52g are aligned with detector element 52e. As before, the detector elements are spaced horizontally at equal distances from each other.

As can be seen, both spots X, which represent the spots projected when the system is reading a CD disk, as well as spots Y, representing the spots projected when the system is reading a DVD disk, are incident on the detectors of multi-element detector 50. For non-central detector elements, spots X are incident on different regions of the detector elements than spots Y, while on the central detector element, the spots are incident on the same region. Due to the angles of the spots, and the elongated shapes and staggered and offset arrangement of the detector elements of multi-element detector 50, multiple tracks may be simultaneously read from either a CD or a DVD disk.

FIG. 7 shows another alternative embodiment of a multi-element detector built in accordance with the principles of the present invention. Multi-element detector 60 comprises detector elements 62a-62g. Central detector element 62d comprises four segments that form a quad detector for use detecting tracking and focus errors, and outermost detector elements 62a and 62g each comprise two segments which may be used to detect magnification errors in the DVD beams.

Detector elements 62a-62c and 62e-62g have elongated shapes, with the height of a detector element varying according to the distance of that detector element from central detector element 62d. Thus, detector elements 62a-62g have a staggered arrangement, with each detector element staggered relative to an adjacent element by a predetermined distance. The centers of detector elements 62a-62g are aligned, so there is no offset between the elements.

Multi-element detector 60 covers a vertical area that becomes larger with distance from central detector element 62d, matching the increasing vertical separation of the spots from the two different media types as the distance from the central spot grows larger. As can be seen, both spots X, projected when the system is reading a CD disk, and spots Y, projected when the system is reading a DVD disk are incident on the detector elements of multi-element detector 60. As in other embodiments, for non-central detector elements, spots X are incident on different regions of the detector elements than spots Y, while on the central detector element, the spots are incident on the same region.

The above-described embodiments of a multi-element detector provide several different multi-element detector geometries that may be used in accordance with the principles of the present invention. It will be apparent that variations of these geometries, and other similar detector geometries may be used to simultaneously read multiple tracks of optical disks of both CD and DVD formats. The multi-channel conditioning circuitry described hereinbelow may be used with any such multi-element detector, and is not intended to be limited to use with only the example embodiments described hereinabove.

Multi-Channel Conditioning Circuitry

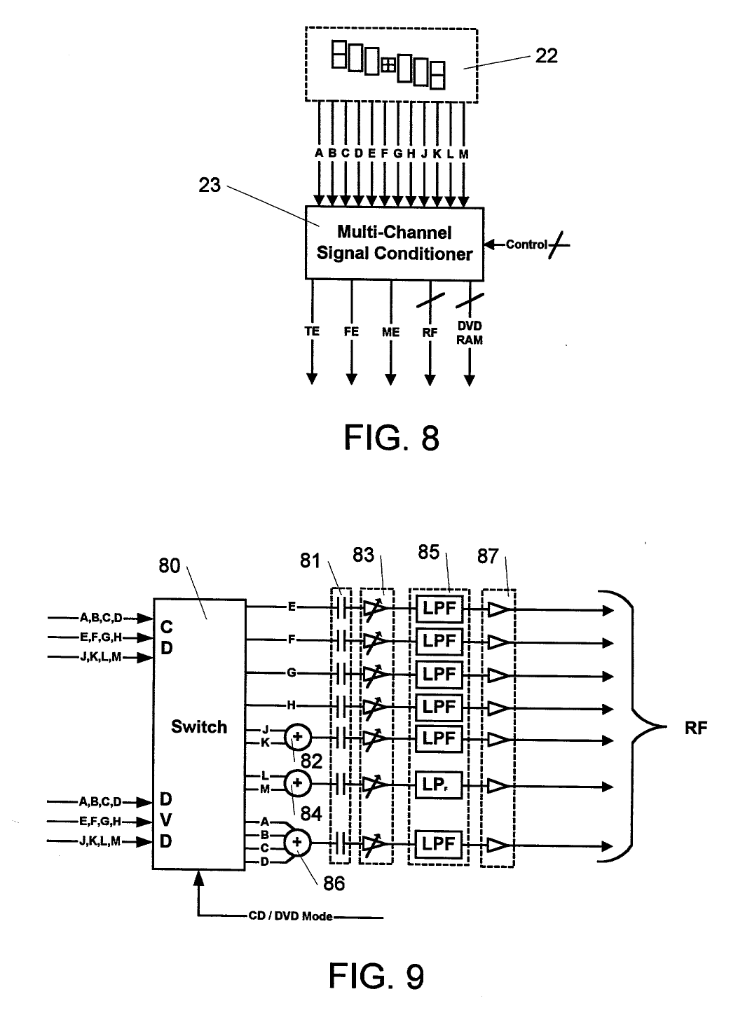

Referring now to FIG. 8, an overview of the multi-channel signal conditioning circuitry of the present invention is described. Multi-channel signal conditioning circuitry 23 receives input signals corresponding to the output of each detector element of multi-element detector 22 or a suitable alternative. Additionally, multi-channel conditioning circuitry 23 receives control signals from processing circuitry 24, or from other control circuitry. These control signals may include a mode control signal that determines whether the optical disk reader is reading a CD or a DVD disk, algorithm selection signals, that determine which algorithms will be used to compute error signals, and other control signals that will be described in detail hereinbelow.

Multi-channel signal conditioning circuitry 23 produces a variety of output signals. The RF signals are the conditioned signals for each of the tracks of the disk that are being simultaneously read. The TE signal is a tracking error signal, the FE signal is a focus error signal, and the ME signal is a magnification/magnitude error signal. The DVD RAM signals are used for header and land/groove detection on DVD-RAM disks. Multi-channel signal conditioning circuitry 23 may also produce other signals (not shown) that may be useful for operating an optical disk reader. In a preferred embodiment, these signals may be buffered by multi-channel signal conditioning circuitry 23, and may be made available as a single multiplexed output signal.

FIG. 9 is a block diagram of a portion of multi-channel signal conditioning circuitry 23 that produces the RF signals for each of the tracks that is being simultaneously read. The signal for each channel is AC coupled, and amplified using a programmable gain, which may be different for each channel. The channels are then filtered and buffered, and may have a programmable output offset voltage applied. For some of the channels, such as the channel for the central beam, for which the reflected light falls on detector segments A, B, C, and D (see, e.g., FIG. 4), it is necessary to sum the signals from several detector segments to produce a signal for the channel.

Switch 80 permits multi-channel conditioning circuitry 23 to be used in systems that use different sets of detectors for reading CD-formatted disks than for reading DVD-formatted disks. Switch 80 takes as input the signals from two multi-element detectors, one associated with reading CD-formatted disks, and one associated with reading DVD-formatted disks. Additionally, switch 80 receives as input a control signal that lets switch 80 know whether the system is in CD mode or DVD mode. Based on the mode, switch 80 selects for output either the set of detector signals associated with reading CD-formatted disks or the set of detector signals associated with reading DVD-formatted disks.

It will be understood by one skilled in the relevant arts that switch 80 is not needed for use in a system such as is shown in FIG. 1, in which beams reflected from both CD and DVD disks are directed onto the same multi-element detector. In such a system, both sets of input signals may come from the same multi-element detector. Since multi-channel signal conditioning circuitry 23 is preferably included on a single integrated circuit, it is preferable to include switch 80, to permit multi-channel signal conditioning circuitry 23 to be used in as many different systems as possible. By including switch 80, multi-channel signal conditioning circuitry 23 may be used in systems having separate optical paths for CD and DVD modes.

Once the correct set of signals is selected by switch 80, some of the signals from the detector segments are summed to produce channel signals. Since the outermost channels each have two detector segments, summing circuits 82 and 84 sum signals from detector segments J and K, and L and M, respectively, to produce channel signals for the outermost two channels. Similarly, summing circuit 86 sums signals from detector segments A, B, C, and D to produce a channel signal for the central channel. The signals from detector segments E, F, G, and H do not need to be summed, since there is a one-to-one correspondence between the signals from these detector segments and a channel signal.

Next, the channel signals are AC coupled by capacitors 81, which prevent any DC component of the signals from passing through to programmable gain amplifiers 83. Alternatively, if the signals are not AC coupled, it may be necessary to subtract a DC offset voltage from each of the signals.

Next, the signals are amplified by programmable gain amplifiers 83. Each one of programmable gain amplifiers 83 may have a different gain value, permitting each signal to be amplified to a different degree. These gains are sent to programmable gain amplifiers 83 as control signals. In a preferred embodiment, each of programmable gain amplifiers 83 may amplify the signal by a factor between 1 (no amplification) and 11.4 (i.e., 1.5⁶), in multiplicative steps of 1.5 (i.e., the gains may be 1, 1.5, 1.5², etc.). It will be understood that the exact gain values that may be used in programmable gain amplifiers 83 may vary according to the design of the system.

The signals are next filtered by low-pass filters 85, which remove high frequency noise from the signals, and are buffered by buffers 87, which may also add an offset DC voltage to the signals. The conditioned RF signals may then be passed on to processing circuitry 24, or to other portions of multi-channel signal conditioning circuitry 23.

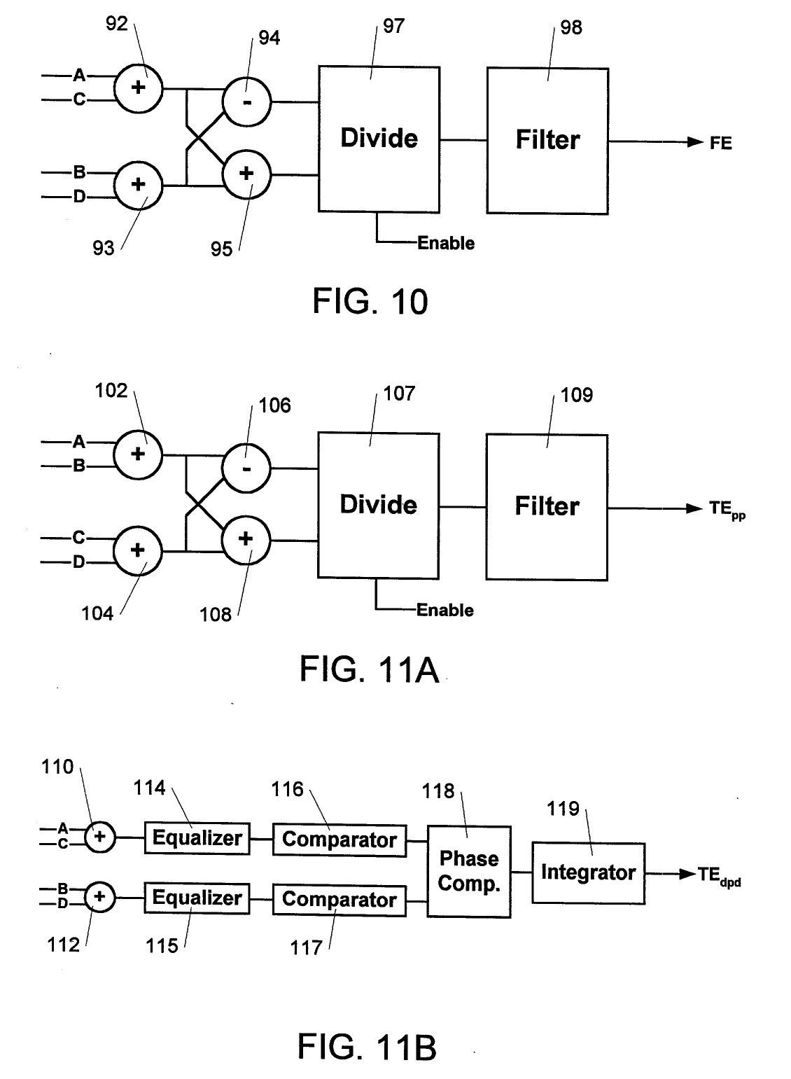

Referring now to FIG. 10, another portion of multi-channel signal conditioning circuitry 23, for computing the focus error signal, FE, is described. Focus error circuitry 90 computes FE using the well-known astigmatic focus error detection method. This method relies on the optics of the system to introduce astigmatism into a reflected beam that is projected onto a quadrant detector. If the system is in focus, the spot projected onto the quadrant detector will be round, illuminating detector segments A, B, C, and D equally. If the system is out of focus, the spot will be elongated diagonally, so that either segments A and C or segments B and D receive greater illumination, depending on the direction of the focus error. Typically, astigmatic focus error is computed by taking the difference of the sums of the signals from the diagonal pairs of detector segments, (A+C)−(B+D). In the circuitry of the present invention, this error value may be normalized.

Summing circuits 92 and 93 sum the signals from A and C, and B and D, respectively. The (A+C) and (B+D) signals are then subtracted by subtraction circuit 94, yielding (A+C)−(B+D). The (A+C) and (B+D) signals are also summed by summing circuit 95, giving (A+B+C+D), for use in normalizing the output signal.

The signals then are sent into divider 97, which optionally normalizes the focus error signal, depending on a “Focus Normalization On/Off” control signal sent to divider 97 by processing circuitry 24 or from other circuitry controlling the operation of the optical drive. If the “Focus Normalization On/Off” control signal indicates that the signal should be normalized, then divider 97 divides the signal from subtraction circuit 94 by the signal from summing circuit 95, yielding ((A+C)−(B+D))/(A+B+C+D). Otherwise, the divider does nothing, and the (A+C)−(B+D) signal from subtraction circuit 94 is left unchanged.

Next, the signal is sent to low-pass filter 98, which removes high frequency components of the signal, making it more suitable for driving a servo system to correct the focus error. In a preferred embodiment, high pass filter 98 provides a output signal having a bandwidth between 100 and 200 KHz.

Referring now to FIG. 11A, a portion of multi-channel signal conditioning circuitry 23 for computing tracking error signal TE is described. Circuitry 100 computes TE using the previously known push-pull method. The push-pull method divides the central quadrant detector into a first portion comprising detector segments A and B, and a second portion comprising segments C and D. Because the line of the spots projected on the disk is nearly tangential to the direction of the tracks, if the tracking is slightly off in a first direction, the first portion of the quadrant detector will receive more light. If the tracking is off in a second direction, then the second portion of the quadrant detector will receive more light. If the tracking is correct, then both the first and second portions of the quadrant detector will have substantially equal amounts of light projected onto them. Thus, a push-pull tracking error signal may be computed as (A+B)−(C+D). In the circuitry of the present invention, this tracking error value may optionally be normalized.

Summing circuits 102 and 104 sum the signals from A and B, and from C and D, respectively. The (A+B) and (C+D) signals are then subtracted by subtraction circuitry 106, yielding (A+B)−(C+D). The (A+B) and (C+D) signals also are summed by summing circuitry 108, giving an (A+B+C+D) signal for use in normalizing the error signal.

Summing circuitry 108 and subtraction circuitry 106 are coupled to divider circuitry 107, which optionally normalizes the tracking error signal. If a “Tracking Normalization On/Off” control signal indicates that the tracking error should be normalized, then divider circuitry 107 divides the (A+B)−(C+D) signal produced by subtraction circuitry 106 by the (A+B+C+D) signal produced by summing circuitry 108, to yield ((A+B)−(C+D))/(A+B+C+D). If the “Tracking Normalization On/Off” control signal indicates that the signal should not be normalized, then the (A+B)−(C+D) signal is passed through divider circuitry 107 unchanged.

The signal is then filtered by low-pass filter 109 to produce a signal suitable for driving a servo to correct tracking errors. In a preferred embodiment, the signal produced by this circuit has a bandwidth between 100 and 200 KHz.

FIG. 11B shows an alternative tracking error detection circuit that uses a previously-known differential phase detection method, such as is described, for example, in Annex C of Standard ECMA-267, for 120 mm DVD—Read-Only Disks, published in December, 1997 by ECMA—European association for standardizing information and communication systems, headquartered in Geneva, Switzerland. This method determines a tracking error by detecting a phase difference between the A+C signal and the B+D signal. If the system is tracking correctly, the projections of pits onto the quad detector will be symmetric. If the system is off track, then one side of the detector will see the pit before the other side, and there will be a phase difference between the A+C and the B+D signals. This differential phase detection tracking is the preferred method of detecting tracking errors in DVD drives.

To compute the tracking error using differential phase detection, the A and C signals are summed by summing circuitry 110, and the B and D signals are summed by summing circuitry 112. The results are passed through equalizers 114 and 115, respectively, which equalize the levels of the signals. The signals are then passed through comparators 116 and 117, which convert the signals to square waves. These square waves are then passed through phase comparators 118, which generates a signal with a positive level during periods when the signal produced from A+C is high and the signal produced from B+D is low, and a negative level during periods when the signal produced from A+C is low and the signal produces from B+D is high. Integrator circuit 119 smooths the signal from phase comparators 118 to produce a signal suitable for driving a servo system to correct the tracking error.

In a preferred embodiment, equalizers 114 and 115 will have five bands, and will have boot frequencies between 6 and 30 MHZ, and boot gains between 3 and 6 dB. Integrator circuit 119 preferably has 16 gain levels, and outputs a signal having a bandwidth between 100 and 200 KHz. It will be understood that the signal from integrator circuit 119 may need to be amplified and filtered before being used to drive a servo system.

In a preferred embodiment of the integrated signal conditioning circuitry of the present invention, both the push-pull tracking error circuitry shown in FIG. 11A and the differential phase detection tracking error circuitry shown in FIG. 11B are present, and the system using the integrated signal conditioning circuitry may select the method that is used to compute the tracking error through use of a tracking algorithm selection control signal. It will be understood that both methods may be used simultaneously, with the results of each method being available for use in driving a servo system to correct tracking error, or for other internal uses. For example, the fast access circuitry described hereinbelow with reference to FIG. 14 uses the tracking error computed using the push-pull method as an input.

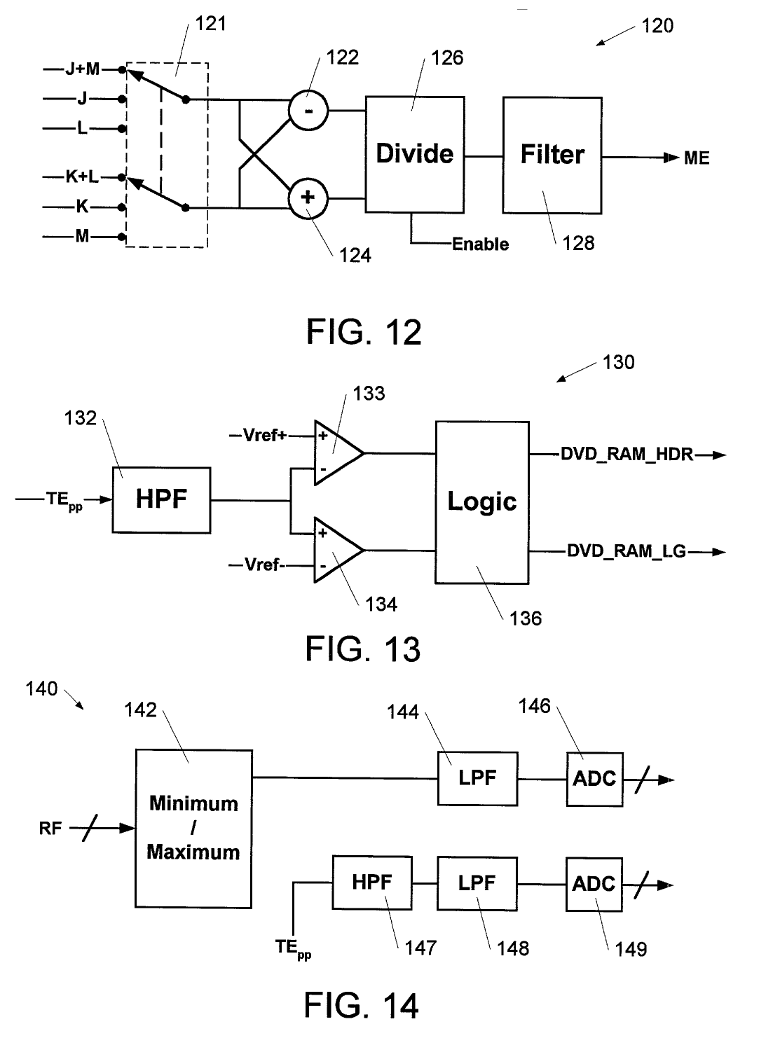

Referring now to FIG. 12, another portion of the multi-channel signal conditioning circuitry of the present invention, for computing a magnification or magnitude error is described. As described hereinabove and in U.S. Pat. No. 5,729,512, magnification errors occur when the reading beams are spaced too far apart for the tracks, or when the reading beams are spaced too closely together. A signal indicative of magnification error may be computed as (J+M)−(K+L). Alternatively, signals indicative of magnification error may be computed as J−K, or as M−L.

Circuitry 120 computes the magnification or magnitude error using any one of these three methods, according to the selection of switch 121, which is controlled by a control signal. Switch 121 may select J+M and K+L (summed by summing circuitry that is not shown) as first and second input signals, J and K as first and second input signals, or M and L as first and second input signals.

The second input signal is subtracted from the first by subtraction circuitry 122. Additionally, the first and second input signals are summed by summing circuitry 124, for use in optionally normalizing the magnification error signal.

Next, the signals produced by subtraction circuitry 122 and summing circuitry 124 are sent to divider circuitry 126, which optionally divides the signal produced by subtraction circuitry 122 by the signal produced by summing circuitry 124, to normalize the signal. If a “Magnification Normalization On/Off” control signal indicates that the signal should be normalized, then this division takes place. Otherwise, the signal from subtraction circuitry 122 is passed through divider circuitry 126 unchanged.

Finally, the signal from divider circuitry 126 is filtered by filter 128, to make it suitable for driving servos, such as are described in U.S. Pat. No. 5,729,512, to correct the magnification error. In a preferred embodiment, the output signal from circuitry 120 has a band width between 10 and 50 KHz.

Referring to FIG. 13, a portion of multi-channel signal conditioning circuitry 23 for handling DVD-RAM signals is shown. DVD-RAM is a re-writeable form of DVD disk, described in detail in Standard ECMA-272, 120 mm DVD Rewriteable Disk (DVD-RAM), 2nd Edition, published in June, 1999. As described in this standard, and other standards directed to DVD-RAM disks, DVD-RAM disks store data both in groove areas (similar to CD-RW disks), as well as in land areas (areas between groove areas). Additionally, each track of a DVD-RAM disk is divided into sectors, each of which has a header. The header areas have pits that are deliberately placed off-track. For land areas, the header pits are off-track in a first direction and switch to being off-track in a second direction. For groove areas, the directions are reversed.

Circuitry 130 is used when reading a DVD-RAM disk to determine whether the system is reading a header area, and whether the system is reading data from a land or a groove. The push-pull tracking error signal, computed by circuitry 100 of FIG. 11A, is used as an input to circuitry 130. High-pass filter 132 removes from the signal any low frequency components indicative of a slow drift in tracking, while leaving components of the signal that may represent the deliberately off-track headers. In a preferred embodiment, high-pass filter 132 has a cutoff frequency of 10 KHz.

Next, comparators 133 and 134 are used to produce signals to indicate when the tracking error is of sufficient magnitude in one direction or the other that it is possible for the tracking error to be caused by a sector header. When the filtered tracking error signal surpasses Vref+, indicating that the tracking is off by a sufficient amount in the first direction, comparators 133 generates a signal that is sent to logic circuitry 136. When the filtered tracking error signal falls below Vref−, indicating that the tracking is off by a sufficient amount in the second direction, comparators 134 generates a signal that is sent to logic circuitry 136.

Logic circuitry 136 performs numerous functions based on the signals received from comparators 133 and 134. Logic circuitry 136 generates the DVD_RAM_HDR signal, indicating that the system is reading a sector header on a DVD-RAM disk, when it sees pulses from comparators 133 and 134 having the appropriate lengths. Additionally, since the sectors have a fixed length and the headers are separated by a fixed distance, logic circuitry 136 may estimate the location of the next header once a header has been detected, increasing the accuracy with which headers are detected.

Logic circuitry 136 also generates the DVD_RAM_LG signal, indicating whether the system is reading from a land or a groove on a DVD-RAM disk. If the header is first off-track in the first directions then off-track in the second direction, then the system is reading a land area. If the header is first off-track in the second direction, then in the first direction, then the system is reading a groove area. Since the system will switch from reading a land to reading a groove, or vice-versa at each full rotation of the disk, logic circuitry 136 may increase the accuracy of the land/groove determination by determining when the disk has made a full rotation. This can be done, for example, by counting the number of headers, since for each zone of a DVD-RAM disk, there are a predetermined number of sectors per rotation of the disk.

Referring now to FIG. 14, another portion of multi-channel conditioning circuitry 23 is described, for assisting in rapidly moving a read head of an optical drive to a particular track on a disk using methods similar to those described in commonly assigned U.S. Pat. No. 5,793,715, which is incorporated herein by reference. Basically, by using the numerous detector elements to detect track crossings, the likelihood of missing a track during rapid movements of the read head is greatly reduced or eliminated. In a preferred embodiment of the present invention, rather than using an elongated beam for detecting track crossings, a plurality of reading beams are used. If any one of the reading beams detects crossing a pit, the system is deemed to have crossed a track.

Circuitry 140 assists in fast access by handling the analog portion of the process. Other portions of the fast access methods may be handled by processing circuitry 24.

the RF signals from each of the multiple detectors are passed through min/max circuitry 142, which extracts the minimum or the maximum signal, depending on a control signal setting. Generally, when a pit from a track is being read, the signal from the sensor onto which the image of the pit is projected will be low. The sensor with the minimum signal is, therefore, assumed to be passing over a pit, which means it is passing over a track. On some systems, the signals from the detectors are inverted before being passed to multi-channel signal conditioning circuitry 23. On these systems, a control signal is used to instruct min/max circuitry 142 to select the maximum signal, rather than the minimum.

Next, low-pass filter 144 filters out all the frequencies of the data, leaving the signal for track crossings. In a preferred embodiment, low-pass filter 144 has a cutoff frequency approximately equal to the highest possible track crossing rate. For example, if the maximum rate of movement for the read head is 1 m/s, and the track pitch is 1.6 microns (i.e., the track pitch for CD-ROM), then the cutoff frequency for low-pass filter 144 should be approximately 625 KHz. If the track pitch is 0.74 microns (i.e., the track pitch for DVD) and the maximum velocity of the read head is 1 m/s, then the cutoff frequency for low-pass filter 144 should be approximately 1.4 MHZ.

The filtered signal is then digitized by analog-to-digital converter (ADC) 146. The digital data from ADC 146 is sent on to processing circuitry 24, which may use the data to count the number of tracks, to achieve rapid and accurate radial positioning of the read head. In a preferred embodiment, ADC 146 produces 3 bits of data per sample.

When the read head is being moved slowly across the disk, signals from the push-pull tracking error detection circuitry described with reference to FIG. 11A may be used to detect track crossings. The push-pull tracking error signal is filtered by high-pass filter 147, and by low-pass filter 148 to remove frequency components from the push-pull tracking error signal that do not represent track crossings. In a preferred embodiment, high-pass filter 147 has a cutoff frequency of approximately 1 KHz, while low-pass filter 148 has an adjustable cut-off frequency similar to that of low-pass filter 144.

The resulting signal is then sent through ADC 149, which digitizes the signal, and sends the digitized data to processing circuitry 24. In a preferred embodiment, ADC 149 produces three bits of data per sample.

While preferred illustrative embodiments of the present invention are described above, it will be evident to one skilled in the art that various changes and modifications may be made without departing from the invention. For example, the multi-element detector and multi-channel signal conditioning circuitry of the present invention could be adapted to handle more or fewer beams. Additionally, circuitry could be added to the multi-channel signal conditioning circuitry of the present invention to handle additional error signals, or to adjust the inputs or outputs to the multi-channel signal conditioning circuitry for use with a variety of detector and servo configurations. It is intended in the appended claims to cover all such changes and modifications which fall within the true spirit and scope of the invention.

What is claimed is:

1. Multi-channel signal conditioning circuitry for use in an optical drive that simultaneously reads multiple tracks from either one of first and second types of optical disks, the first and second types of optical disks having different track pitches and data densities, the multi-channel signal conditioning circuitry comprising:
a switch that selectively switches between a first set of inputs signals from multiple tracks of the first type of optical disk and a second set of inputs signals from multiple tracks of the second type of optical disk, the switch producing a set of data signals;
focus error detection circuitry that produces a focus error signal from a first subset of data signals selected from the set of data signals;
tracking error detection circuitry that produces a tracking error signal from a second subset of data signals selected from the set of data signals;
magnification error detection circuitry that produces a magnification error signal from a third subset of data signals selected from the set of data signals; and
a plurality of filter circuits, each one of the filter circuits using one or more of the data signals from the set of data signals to produce a filtered output signal representing the data of one of the multiple tracks of either the first type or the second type of optical disk.

2. The multi-channel signal conditioning circuitry of claim 1, wherein the focus error detection circuitry comprises astigmatic focus error detection circuitry and the first subset of data signals comprises data signals produced by four quadrants of a quadrant detector.

3. The multi-channel signal conditioning circuitry of claim 2, wherein the focus error detection circuitry comprises:
first and second summing circuitry for computing first and second sums of pairs of data signals selected from the first subset of data signals; and
subtraction circuitry coupled to the first and second summing circuitry, the subtraction circuitry computing a difference between the first and second sums.

4. The multi-channel signal conditioning circuitry of claim 3, wherein the focus error detection circuitry further comprises divider circuitry that optionally normalizes the difference computed by the subtraction circuitry.

5. The multi-channel signal conditioning circuitry of claim 1, wherein the tracking error detection circuitry comprises push-pull tracking error detection circuitry and the second subset of data signals comprises data signals produced by four quadrants of a quadrant detector.

6. The multi-channel signal conditioning circuitry of claim 5, wherein the tracking error detection circuitry comprises:
first and second summing circuitry for computing first and second sums of pairs of data signals selected from the second subset of data signals; and
subtraction circuitry coupled to the first and second summing circuitry, the subtraction circuitry computing a difference between the first and second sums.

7. The multi-channel signal conditioning circuitry of claim 6, wherein the tracking error detection circuitry further comprises divider circuitry that optionally normalizes the difference computed by the subtraction circuitry.

8. The multi-channel signal conditioning circuitry of claim 1, wherein the tracking error detection circuitry comprises differential phase detection circuitry, and the second subset of data signals comprises data signals produced by four quadrants of a quadrant detector.

9. The multi-channel signal conditioning circuitry of claim 8, wherein the differential phase detection circuitry comprises:
first and second summing circuitry that produce first and second sums of pairs of data signals from the second subset of data signals; and
phase comparators circuitry that produces a signal indicative of the difference in phase between the first and second sums.

10. The multi-channel signal conditioning circuitry of claim 1, wherein the tracking error detection circuitry comprises both push-pull tracking error detection circuitry and differential phase detection circuitry, and the second subset of data signals comprises data signals produced by four quadrants of a quadrant detector.

11. The multi-channel signal conditioning circuitry of claim 10, wherein an algorithm select control signal is used to select whether the push-pull tracking error detection circuitry or the differential phase detection circuitry is used to compute the tracking error signal.

12. The multi-channel signal conditioning circuitry of claim 1, wherein the first type of optical disk comprises a disk conforming to a CD-ROM standard, and the second type of optical disk comprises a disk conforming to a DVD standard.

13. The multi-channel signal conditioning circuitry of claim 1, further comprising circuitry that determines whether an optical drive is reading a land area or a groove area of a DVD-RAM formatted disk.

14. The multi-channel signal conditioning circuitry of claim 1, further comprising circuitry that determines whether an optical drive is reading a header area of a DVD-RAM disk.

15. The multi-channel signal conditioning circuitry of claim 1, further comprising circuitry that assists in rapidly positioning a read head of an optical drive over a selected track of an optical disk.

16. A detector system for use in an optical drive that simultaneously reads a plurality of data tracks from either one of first and second types of optical disks, the first and second types of optical disks having different track pitches and data densities, the system comprising:
a multi-element detector comprising a plurality of detector elements, each one of the plurality of detector elements spaced apart equidistant from adjacent ones of the plurality of detector elements along a first axis and, for at least a subset of the plurality of detector elements, each one of the subset of detector elements having a portion that is staggered by a predetermined distance relative to an adjacent detector element in a direction perpendicular to the first axis; and
multi-channel signal conditioning circuitry coupled to the multi-element detector, the multi-channel conditioning circuitry comprising filtering circuitry that filters a signal produced by each one of the plurality of detector elements to produce an output signal, focus error detection circuitry that detects a focus error, and tracking error detection circuitry that detects a tracking error.

17. The detector system of claim 16, wherein a central one of the plurality of detector elements comprises a quadrant detector having four detector segments, and wherein output signals from the four detector segments are used by the focus error detection circuitry and the tracking error detection circuitry.

18. The detector system of claim 17, wherein the focus error detection circuitry comprises astigmatic focus error detection circuitry.

19. The detector system of claim 17, wherein the tracking error detection circuitry comprises push-pull tracking error detection circuitry.

20. The detector system of claim 17, wherein the tracking error detection circuitry comprises differential phase detection circuitry.

21. The detector system of claim 17, wherein the tracking error detection circuitry comprises both push-pull tracking error detection circuitry and differential phase detection circuitry.

22. The detector system of claim 16, wherein the multi-channel signal conditioning circuitry further comprises magnification error detection circuitry that produces an error signal indicative of a magnification error.

23. The detector system of claim 16, wherein the first type of optical disk comprises a disk conforming to a CD-ROM standard, and the second type of optical disk comprises a disk conforming to a DVD standard.

24. The detector system of claim 16, wherein the multi-channel signal conditioning circuitry further comprises circuitry that determines whether an optical drive is reading a land area or a groove area of a DVD-RAM formatted disk.

25. The detector system of claim 16, wherein the multi-channel signal conditioning circuitry further comprises circuitry that determines whether an optical drive is reading a header area of a DVD-RAM disk.

26. The detector system of claim 16, wherein the multi-channel signal conditioning circuitry further comprises circuitry that assists in rapidly positioning a read head of an optical drive over a selected track of an optical disk.

27. A method of simultaneously reading a plurality of data tracks from either one of first and second optical disks having different formats, the method comprising:
providing a central detector element and a plurality of non-central detector elements, the central detector element and the plurality of non-central detector elements producing a plurality of data signals;
generating a plurality of reading beams including a plurality of non-central reading beams;
focusing the plurality of non-central reading beams onto a surface of one of the first or second optical disks to generate a plurality of non-central reflected beams, each one of the plurality of non-central reading beams being focused onto a corresponding one of plurality of data tracks to generate a corresponding one of the plurality of non-central reflected beams;
if the first optical disk is read, projecting each one of the plurality of non-central reflected beams onto a first region of each one of the plurality of non-central detector elements, and if the second optical disk is read, projecting each one of the plurality of reflected beams onto a second region of each one of the plurality of non-central detector elements, the first region of each one of the plurality of non-central detector elements is spaced apart from the second region of that non-central detector element; and
sending the plurality of data signals to multi-channel conditioning circuitry that filters the plurality of data signals to produce a plurality of output signals, detects a focus error, and detects a tracking error.

28. The method of claim 27, wherein providing a central detector element comprises providing a central detector element having four detector segments arranged to form a quadrant detector, each one of the four detector segments producing a signal indicative of an amount of light incident on that detector segment.

29. The method of claim 28, further comprising:
adding astigmatism to at least a central reading beam of the plurality of reading beams;
projecting a reflected beam corresponding to the central reading beam onto the central detector element; and
generating a focus error signal in the multi-channel conditioning circuitry, the focus error signal responsive to the signals produced by the four detector segments.

30. The method of claim 28, further comprising generating a tracking error signal in the multi-channel signal conditioning circuitry, using a push-pull technique to generate the tracking error signal responsive to the signals produced by the four detector segments.

31. The method of claim 28, further comprising generating a tracking error signal in the multi-channel signal conditioning circuitry, using a differential phase detection technique to generate the tracking error signal responsive to the signals produced by the four detector segments.

32. The method of claim 28, further comprising generating a magnification error signal in the multi-channel signal conditioning circuitry.

33. The method of claim 27, further comprising generating a signal in the multi-channel signal conditioning circuitry that indicates whether an optical drive is reading a land area or a groove area of a DVD-RAM formatted disk.

34. The method of claim 27, further comprising generating a signal in the multi-channel signal conditioning circuitry that indicates whether an optical drive is reading a header area of a DVD-RAM disk.

35. The method of claim 27, further comprising generating a fast access signal in the multi-channel signal conditioning circuitry, the fast access signal assisting in rapidly positioning a read head of an optical drive over a selected track of an optical disk.
